(19) United States
(12) Patent Application Publication
(10) Pub. No.: US 2017/0132804 A1
(43) Pub. Date: May 11, 2017

(54) SYSTEM AND METHOD FOR IMPROVED COMPUTATIONAL IMAGING

(71) Applicant: Duke University, Durham, NC (US)

(72) Inventors: David Jones Brady, Durham, NC (US); Lawrence L. Carin, Chapel Hill, NC (US); Patrick R. Liull, Durham, NC (US); Xin Yuan, Durham, NC (US)

(21) Appl. No.: 15/317,913

(22) PCT Filed: Jun. 12, 2015
(86) PCT No.: PCT/US15/35554

§ 371 Date: Dec. 9, 2016

Related U.S. Application Data
(60) Provisional application No. 62/011,129, filed on Jun. 12, 2014.

(51) Int. Cl. G06T 7/571; H04N 5/225

(52) U.S. Cl. CPC G06T 7/571; H04N 5/2254; G06T 2207/10028; G06T 2207/10144; G06T 2200/21; G06T 2207/10052

(57) ABSTRACT

A system and method for computing a digital image of a scene, where the digital image contains enhanced depth information are disclosed. Embodiments of the present invention form a light distribution on a focal-plane array, where the light distribution is based on an optical image of the scene formed by a lens system. During the exposure period of the focal-plane array, longitudinal and transverse motion are imparted between the light distribution and the focal-plane array, which encodes depth information on the blur kernel of the lens system, thereby generating an encoded digital output signal. A depth-information-enhanced digital image of the scene is computed by deconvolving the encoded digital output signal with the blur kernel of the lens system and a model of the transverse motion.

### CROSS REFERENCE TO RELATED APPLICATIONS

This application claims the benefit of U.S. Provisional Application Ser. No. 62/011,129, filed Jun. 12, 2014, entitled “Systems and Methods for Image Translation for Computational Imaging,” (Attorney Docket DU4366PROV), which is incorporated by reference. If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to computational imaging in general, and, more particularly, to forming digital images having improved quality, such as three-dimensional images and extended depth-of-field images.

### BACKGROUND OF THE INVENTION

A camera is an optical instrument in which a lens system captures light from a scene and forms an optical image at its focal plane. The optical image manifests as an illumination pattern formed on a recording medium, such as photographic film or an array of sensor elements (i.e., a “focal-plane array”), which is typically located at or near the focal plane of the lens system. For a photographic-film-based camera, the captured image is proportional to the illumination pattern and is permanently imprinted on the film. A digital camera, however, estimates an image of the scene using digital processing of the illumination pattern as recorded by the sensor elements of its focal-plane array. In conventional practice, the digital processing also provides noise reduction, as well as correction of non-uniformity and distortion. Despite the advances of digital processing, the idea that a captured image has a one-to-one correspondence to (i.e., is isomorphic to) and proportional to the illumination pattern at the moment of capture persists in current camera design.

The purpose of a camera is to create an image of a real-world scene (also referred to as a real-world object). Real-world scenes are five-dimensional (5D) distributions that include three spatial dimensions, time, and color. A conventional camera collapses these distributions to two dimensions in space, with interlaced or layered sampling of color and sequential sampling of time. As a result, a great deal of information about the real-world scene is not recovered by the recording medium, thereby degrading spatial and longitudinal resolution and limiting the depth-of-field (DOF) of the resultant image.

Computational imaging offers a hope for recovering much of the heretofore unrecovered information, however, thereby improving the capabilities of a camera in ways that are not possible with film-based imaging systems. In contrast to standard imaging approaches, computational imaging does not presume isomorphism between the physical structure of a scene and its reconstructed image. Instead, in the design of computation imaging systems, physical measurements are “coded” to enable computational “decoding” during image reconstruction and, thereby, an improvement in metrics in the reconstructed image. Computational imaging has been used to develop in-camera computation of digital panoramas and high-dynamic-range images, as well as light-field cameras, which enable generation of three-dimensional images, enhanced of depth-of-field (EDOF), and selective re-focusing (or “post focus”).

Several approaches for improving image reconstruction using computational imaging have been developed in the prior art, including inter-pixel interpolation and coded-aperture imaging systems.

Interpolation can be used to improve the visual quality of a reconstructed image by “filling in” the regions that lie between the sensor elements of a focal-plane array. Under best practice, nonlinear estimation algorithms accounting for the values in all color layers are used to complete the two-dimensional spatial and one-dimensional color data cube from the joint set of color-plane measurements. These sampling strategies assume, however, that the measurement is isomorphic to the scene image. Unfortunately, this conventional strategy does not account for the three-dimensional spatial structure of the object space of the scene. In other words, depth information in the scene is not recovered.

Coded-aperture imaging “structures” the optical response of an optical system (i.e., its impulse response, or “point-spread function (PSF),” h(x,x′,y,y′,λ,t)) and then reimages its generated light distribution onto a focal-plane array. It should be noted that coded-aperture-based sampling is an example of computational imaging because: (1) the PSF of the optical system is coded such that measured data is not isomorphic to the scene data cube (the data cube must be estimated from digital processing); and (2) because prior information (such as sparsity or smoothness) is applied to allow decompressive estimation of the scene. Computational imaging requires both (1) and (2) for the construction of an accurate forward model corresponding to h(x,x′,y,y′,λ,t) and the construction of an accurate object model corresponding to the priors used to regularize inversion.

Yet another computational imaging approach relies on the combination of a coded aperture with spectral dispersion, which enables high-resolution reconstruction of the spatio-spectral subspace of the datacube, as disclosed by Wagadarikar, et al., in “Single disperser design for coded aperture snapshot spectral imaging,” Applied Optics, Vol. 47, pp. B44-B51 (2008). In addition, translation of a coded aperture during image acquisition adds temporal variation to the PSF of the optical system and enables the use of identical mathematical strategies to reconstruct multiple temporal frames from a single recorded frame, as discussed by Llull, et al., in “Coded aperture compressive temporal imaging.” Optics Express, Vol. 21, pp. 10526-10545 (2013). Further, this strategy can be extended to volume imaging of a scene by sweeping the focus position of the lens during single-frame acquisition, as disclosed by Yuan, et al., in “Low-Cost Compressive Sensing for Color Video and Depth,” in arXiv preprint arXiv:1402.6932 (2014). Still further, the coded-aperture compression strategy is a specific example of compressive measurement strategies disclosed by Brady, et al., in U.S. Pat. Nos. 7,432,843, 7,463,174, and 7,463,179.

Unfortunately, prior-art coded-aperture-imaging approaches are non-ideal because: (1) relay optics used to image the code plane onto the detector increase the complexity and volume of the optical system; and (2) accurate characterization of the forward model is challenging.

### SUMMARY OF THE INVENTION

The present invention enables a system and method for computing a digital image of a scene such that the resultant image has enhanced spatial, temporal, and/or depth resolution without some of the costs and disadvantages of the prior art. Embodiments of the present invention are well suited to forming high-resolution images, such as three-dimensional images and/or enhanced depth-of-field images of the scene. Further, the augmented information can be recovered during a single image frame, making real-time imaging applications, such as three-dimensional video, feasible.

The present invention employs longitudinal and transverse image translation, during a single-frame exposure, to encode the transfer function of the optical system thereby improving camera sampling efficiency. This enables increased information rates in sampling and improved reconstructed image quality using computational imaging techniques. Embodiments of the present invention form a light distribution on a focal-plane array, where the light distribution is based on an optical image of the scene formed by a lens system. During the exposure period of the focal-plane array, relative longitudinal and transverse motion are simultaneously imparted between the light distribution and the focal-plane array, which encodes depth information on the blur kernel of the lens system, thereby generating an encoded digital output signal. A depth-information-enhanced digital image of the scene is computed by deconvolving the encoded digital output signal with the blur kernel of the lens system and a model of the transverse motion.

An illustrative embodiment is a camera comprising a lens system and a focal-plane array that collectively define an optical axis, as well as an actuator for imparting transverse motion on the focal-plane array. The lens system forms an optical image at a first point on the optical axis, which gives rise to a light distribution on the focal-plane array, which is located at a second point on the optical axis. Within the duration of a single exposure period of the focal-plane array: (1) the focal length of the lens system is scanned through a range of focal lengths, thereby imparting longitudinal motion on the light distribution relative to the focal-plane array; and (2) the focal-plane array is moved along a path that is transverse to the optical axis. By virtue of the scanned focal length and the transverse motion of the focal-plane array, depth information about the scene is encoded in the digital output signal of the focal-plane array to form an encoded digital output signal. This depth information is recovered by deconvolving the encoded digital output signal with a blur kernel for the lens system.

In some embodiments, relative motion between the light distribution and the focal-plane array is induced such that the motion is at least partially in a plane that is orthogonal to the optical axis. In some embodiments, the relative motion includes a curved path within the plane. In some embodiments, the relative motion includes a circular path within the plane. In some embodiments, the relative motion includes a linear path within the plane.

In some embodiments, the relative motion is induced by moving at least a portion of the lens system. In some embodiments, the relative motion is induced by moving the focal-plane array. In some embodiments, the relative motion is induced by moving both the focal-plane array and at least a portion of the lens system.

In some embodiments, relative lateral motion between the light distribution and focal-plane array is implemented using a conventional camera “optical image stabilization” system. In some embodiments, relative longitudinal motion between the light distribution and the focal-plane array is implemented via the conventional camera focus adjustment. In some embodiments, relative longitudinal motion between the light distribution and the focal-plane array is implemented by physically moving the focal-plane array along the optical axis of the lens system. In some embodiments, relative longitudinal motion between the light distribution and the focal-plane array is implemented by physically moving at least a portion of the lens system relative to the focal-plane array along the optical axis of the lens system.

In some embodiments, the depth-information-enhanced digital image of the scene is computed by deconvolving the encoded digital output signal with a calibrated multi-dimensional impulse response of the lens system.

In some embodiments, a digital image of a scene is estimated using more pixels in the four-dimensional transverse space, longitudinal space and temporal data cube than the number of sensor pixels included in the focal-plane array.

An embodiment of the present invention is a method for forming a digital image of a scene, the method comprising: forming an optical image at a first position on a first axis; locating a focal-plane array at a second position on the first axis, wherein the first position and second position are separated along the first axis by a first distance; receiving a light distribution at the focal-plane array, the light distribution being based on the optical image and the first distance; converting the light distribution into a digital output signal over a first exposure period; controlling at least one of the first position and the second position to scan the first distance through a first range during the first exposure period; and inducing a first relative motion between the focal-plane array and the light distribution during the first exposure period, wherein the first relative motion is unaligned with the first axis; wherein the scanning of the first distance through the first range and the first relative motion collectively encode the digital output signal to form an encoded digital output signal.

### BRIEF DESCRIPTION OF THE DRAWINGS

FIG. 1 depicts a schematic drawing of a computational imaging system in accordance with an illustrative embodiment of the present invention.

FIG. 2 depicts operations of a method for generating a digital image of a scene in accordance with the illustrative embodiment of the present invention.

FIG. 3 depicts a plot of the focus of lens 102 over a series of representative exposure frames in accordance with the illustrative embodiment.

FIG. 4 depicts a schematic drawing showing that the support of [symbol] (u) [symbol] (u) [symbol] (v) in the Fourier (u,v) plane defines the “passband” of the measurement system in accordance with the present invention.

FIG. 5 depicts a simulated PSF for a camera having a stationary focal-plane array.

FIGS. 6A-B depict simulated PSFs for two points in the object space of camera 100, wherein the PSFs re obtained while focal-plane array 104 is moved linearly in a transverse direction during an exposure frame in accordance with the present invention.

FIG. 7 depicts the simulated PSF for camera 100 at different ranges in accordance with the illustrative embodiment of the present invention.

FIG. 8 depicts four different well-known simulation images provided as an in-focus simulated object.

FIG. 9 depicts an arrangement of camera 100 and objects 800, 802, 804, and 806, wherein the four objects are located at different distance along the z-axis of the camera.

FIG. 10A depicts reconstructed images 800, 802, 804, and 806 where one focus position is used.

FIG. 10B depicts the reconstructed images, where each is deconvolved with its perpetrating kernel.

FIG. 11 depicts plots of the conventional blur kernels for the reconstructed images depicted in plot 1002.

FIG. 12 depicts plots of EDOF kernels taken with induced longitudinal motion between light distribution LD(x) and focal-plane array 104 (i.e., with a focal sweep of lens 102) but without transverse motion of the focal-plane array.

FIG. 13 depicts plots of the cross-sections of the EDOF kernels shown in FIG. 12. The cross-sections shown in FIG. 13 illustrate that these focal-sweep kernels are substantially depth invariant.

FIG. 14A depicts reconstructed images 800, 802, 804, and 806 as corrupted by the EDOF kernels taken with induced longitudinal motion but without transverse motion of focal-plane array 104.

FIG. 14B depicts the reconstructed images shown in plot 1400. Each image in plot 1402 is deconvolved with its perpetrating kernel.

FIG. 15 depicts plots of the peak signal-to-noise values for images 800, 802, 804, and 806 after deconvolution.

FIG. 16 depicts plots of EDOF kernels taken with induced longitudinal and linear transverse motion. FIG. 16 shows the kernel for the target object distances with v=10 pixels/Δt.

FIG. 17A depicts reconstructed images 800, 802, 804, and 806 as corrupted by the EDOF kernels taken with induced longitudinal motion between light distribution LD(x) and focal-plane array 104 and transverse motion of the focal-plane array in one dimension.

FIG. 17B depicts the reconstructed images shown in plot 1700. Each image in plot 1702 is deconvolved with its perpetrating kernel.

FIG. 18 depicts plots of the peak signal-to-noise values for images 800, 802, 804, and 806 after deconvolution as depicted in plot 1702.

FIG. 19 depicts plots of blur kernels taken with induced longitudinal motion between light distribution LD(x) and focal-plane array 104 and transverse motion of the focal-plane array in two dimensions.

FIG. 20A depicts reconstructed images 800, 802, 804, and 806 as corrupted by the EDOF kernels taken with induced longitudinal motion between light distribution LD(x) and focal-plane array 104 and transverse motion of the focal-plane array in two dimensions.

FIG. 20B depicts the reconstructed images shown in plot 2000. Each image in plot 2002 is deconvolved with its corresponding blur kernel.

FIG. 21 depicts plots of the peak signal-to-noise values for images 800, 802, 804, and 806 after deconvolution as depicted in plot 2002.

### DETAILED DESCRIPTION

Embodiments of the present invention employ image translation as a coding mechanism to improve the quality of a reconstructed image in computational imaging systems. Specifically, the image translation includes simultaneous relative lateral and longitudinal motion between a focal-plane array of the imaging system and a physical light distribution provided to it by the optics of the imaging system during each exposure frame of the imaging system.

Computational imaging relies on a model for the physical image capture process, wherein the image, g(x,y,z,t) (where x, y, and z are spatial coordinates in the image space of lens 102) is a function of the physical measurements f(x′,y′,z′,λ,t) of the scene being imaged (where x′, y′, and z′ are spatial coordinates in the object space of lens 102), as influenced by the optical characteristics of the imaging system—specifically, its PSF, h(x,x′,y,y′,z,z′,λ). Actual measurements in a modern digital imaging system consist of discrete samples of g(x,y,t) with an appropriate sampling structure. Also, focal imaging systems are typically “shift invariant” such that the optical system's impulse response depends only on the separation between the object-space and image-space spatial variables.

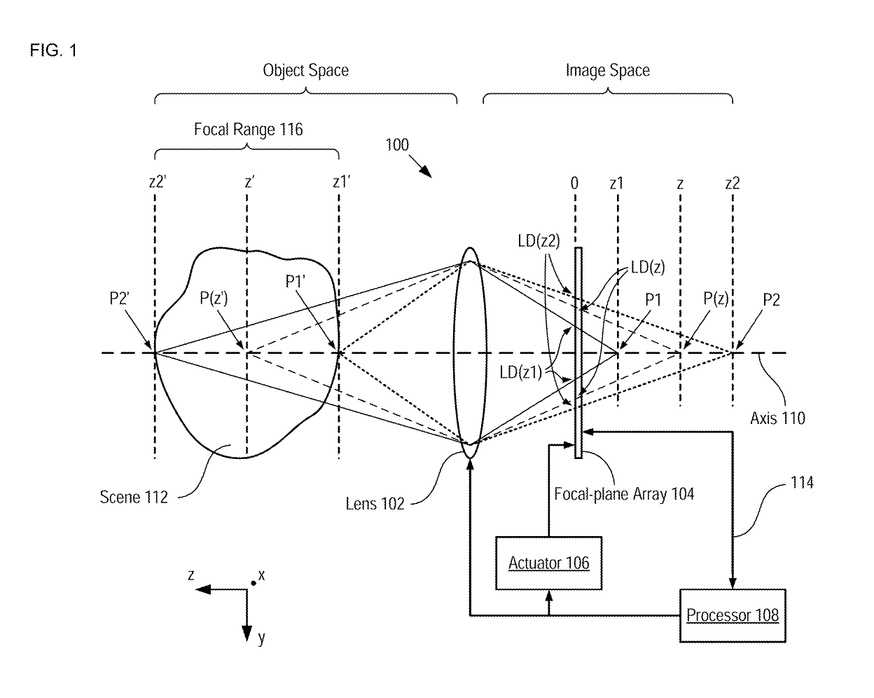

FIG. 1 depicts a schematic drawing of a computational imaging system in accordance with an illustrative embodiment of the present invention. Camera 100 is a digital camera for forming an extended depth-of-field digital image of scene 112. Camera 100 includes lens 102, focal-plane array 104, motion system 106, and processor 108. Lens 102 and focal-plane array 104 are arranged to collectively define optical axis 110. In some embodiments, camera 100 is dimensioned and arranged to provide digital images of scene 112 that:
i. have improved spatial resolution; or
ii. have improved temporal resolution; or
iii. have enhanced depth-of-field; or
iv. are substantially three-dimensional images; or
v. any combination of i, ii, ii, and iv.

Lens 102 is a conventional camera lens system, such as a lens system suitable for use in a hand-held digital camera. Lens 102 has variable focus and can be focused anywhere within a focal range from z1 to z2 (i.e., focal range 116). In the depicted example, ranges z1 and z2 coincide with the depth extremes of scene 112. One skilled in the art will recognize how to specify, make, and use lens system 102. Typically, lens 102 comprises a plurality of lens elements, where at least one of the lens elements is independently movable along optical axis 110 with respect to other lens elements to enable focus control.

Defining the measurement plane of camera 100 (i.e., the surface of focal-plane array 104) as z=0, mathematically, the mapping between scene 112 and the image formed by lens 102 can be described by:

g(x, y, t)=∫f(x′, y′, z′, λ, t)h(x, x′, y, y′, z′, λ)dx′dy′dzdλ. (1)

Neglecting non-uniform optical aberration, the object-measurement mapping can be considered shift-invariant within a single color band (i.e., for any single color). As a result, equation (1) above takes the form:

gᵢ(x,y,t)=∫f(x′, y′, z′, λ, t)hᵢ(x−x′, y−y′, −z′, λ)dx′dy′dzdλ, (2)

where h(x,y,z,λ) combines the optical PSF and the i^{th} color filter response function. Note that each color plane can be considered as an independent image sampled only at pixels for which that particular color filter is active.

In the depicted example, lens 102 forms an optical image of all points (x′,y′,z′) in the object space of the lens at points (x,y,z) in the image space of the lens, which gives rise to light distribution LD(z) on focal-plane array 104. As discussed below, the configuration of the light distribution on the focal-plane array depends on where in the image space of lens 102 the scene is formed, relative to the focal-plane array, which depends on the range, z, at which the lens is focused in its object space.

Focal-plane array 104 is a conventional two-dimensional array of sensor elements, each of which is operative for receiving a portion of light distribution LD(z) and providing a corresponding electrical signal having a magnitude based on the intensity of the light portion incident upon it. Sensor elements suitable for use in embodiments of the present invention include charge-coupled devices (CCDs), photodetectors, photodiodes, phototransistors, and the like.

Focal-plane array 104 provides output signal 114 to processor 108, where output signal 114 is representative of the light distribution incident on its array of sensor elements. One skilled in the art will recognize that a focal-plane array is typically characterized by an “exposure period,” which, for the purposes of this Specification, including the appended claims, is defined as the time required for a focal-plane array to convert a light distribution incident upon it into an output signal representative of that light distribution. Normally, the duration of each exposure frame of camera 100 is equal to this exposure period, which determines the frame rate of the camera.

Actuator 106 is a conventional mechanical translation device that is operatively coupled with focal-plane array 104 such that the actuator can move the focal-plane array along a path that is at least partially unaligned with optical axis 110. For the purposes of this Specification, including the appended claims, “unaligned” with optical axis 110 is defined as being neither co-linear nor parallel to the optical axis. In other words, actuator 106 moves focal-plane array along a path having at least a portion that forms an angle having a magnitude between 0° and 180° with optical axis 110. Preferably, actuator 106 moves focal-plane array along a path having at least a portion that lies in a plane that is substantially orthogonal to optical axis 110 (e.g., the x-y plane located at z=0). In the illustrative embodiment, actuator 106 is a conventional optical-image-stabilization system, such as those routinely included in hand-held digital cameras. In some embodiments, actuator 106 is another actuator operative for imparting a motion on focal-plane array 104, wherein the motion includes a path that is in a direction transverse to optical axis 110. In some embodiments, actuator 106 is operative coupled to lens 102 such that it imparts a motion on the lens that gives rise to a transverse motion of the light distribution incident on focal-plane array 104.

In some embodiments, actuator 106 is a passive system that enables transverse relative motion between the light distribution on focal-plane array 104 and the focal-plane array in response to an externally applied motion. For the purposes of this Specification, including the appended claims, “externally applied motion” is defined as an external force applied to camera 100, such as motion of a hand that is holding the camera, etc.

Processor 108 is a conventional computer processing system that is operative for performing image processing and deconvolution of output signal 114 to generate a digital image of scene 112. Processor 108 also provides control signals to lens 102, focal-plane array 104, and actuator 106 to control the relative motion between the light distribution and the focal-plane array, as well as synchronize the relative motion with the exposure period of the focal-plane array (i.e., its frame rate).

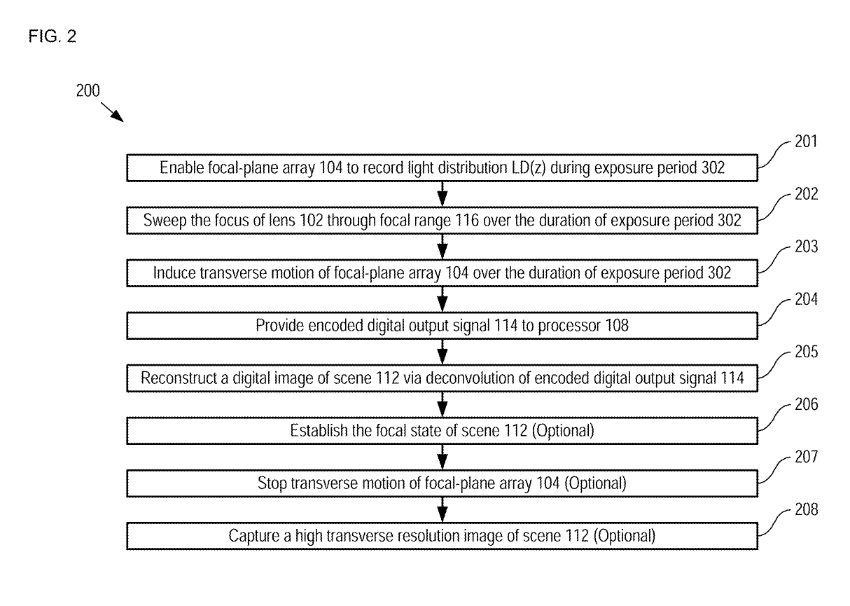

FIG. 2 depicts operations of a method for generating a digital image of a scene in accordance with the illustrative embodiment of the present invention. Method 200 begins with operation 201, wherein, for an exposure period from time period from t=0 to time t=T, focal-plane array 104 is enabled to record light distribution LD(z).

At operation 202, the focus of lens 102 is swept through focal range 116 over the duration of exposure period 302. In operation 202, the focus of lens 102 is swept, at a constant rate, from z1′ to z2′. As a result, the position on the optical axis at which the optical image of the scene is formed (and, therefore the distance between it and focal-plane array 104) is swept from P1 to P2. As mentioned briefly above, by scanning the separation between the optical image and the focal plane array through a range of values, the light distribution incident on the focal-plane array is continuously changed as well. For the purposes of this Specification, including the appended claims, this is defined as imparting a longitudinal motion on light distribution LD(z) relative to focal-plane array 104. In some embodiments, this relative longitudinal motion is achieved by keeping the focus of lens 102 constant and physically moving focal-plane array 104 along optical axis 110.

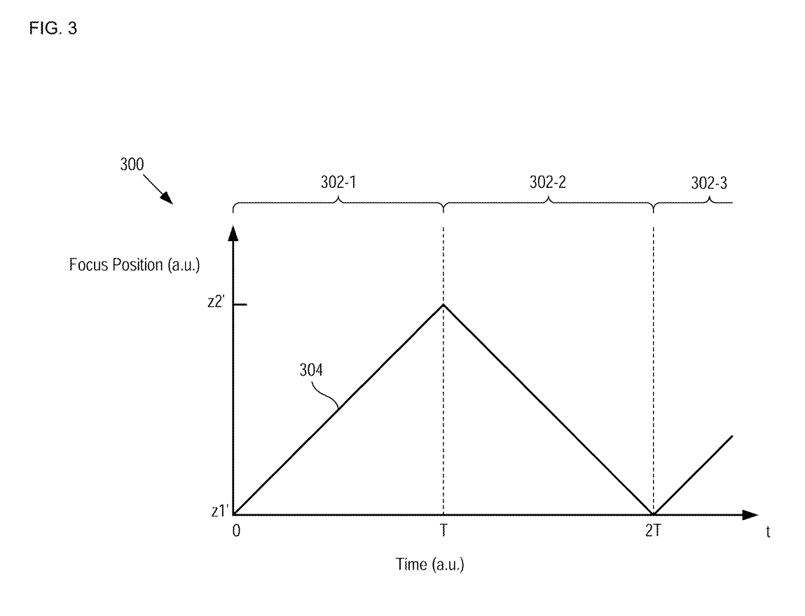

FIG. 3 depicts a plot of the focus of lens 102 over a series of representative exposure frames in accordance with the illustrative embodiment. Plot 300 depicts the focal position 304 of lens 102 over three exposure frames 302, each having an exposure period of T. For illustrative purposes, in the depicted example, an exposure frame of camera 100 is equal to the exposure period of focal-plane array 104; however, one skilled in the art will recognize that the exposure frame of the camera can be different than the exposure period of the focal-plane array without departing from the scope of the present invention.

One skilled in the art will recognize that, when lens 102 is focused at range z=z1′, the region of scene 112 located at plane z1′ is focused at plane z1 (i.e., position P1′ is focused at position P1). This gives rise to light distribution LD(z1) on focal-plane array 104. In similar fashion, when lens 102 is focused at range z=z2′, the region of scene 112 located at plane z2′ is focused at plane z2 (i.e., position P2′ is focused at position P2). This gives rise to light distribution LD(z2) on the focal-plane array. As the focus of lens 102 scans between z1′ and z2′, the point on optical axis 110 at which the optical image of scene 112 is formed moves between P1 and P2, and the light distribution on the focal-plane array, LD(z), smoothly transitions from LD(z1) to LD(z2) over the course of the exposure frame.

In the illustrative embodiment, the relative longitudinal motion between light distribution LD(z) and focal-plane array 104 is attained by sweeping the focus of lens 102 from z1′ to z2′ during exposure period 302-1, sweeping it back from z2′ to z2′ during exposure period 302-2, and so on. This mitigates delays between exposure frames due to the need to return the focus of lens 102 back to the same position after every exposure frame. One skilled in the art will recognize, after reading this Specification, however, that myriad alternative focus sweeping strategies exist within the scope of the present invention.

At operation 203, a relative transverse motion between light distribution LD(z) and focal-plane array 104 is induced over the duration of each exposure period 302. In the depicted example, actuator 106 moves focal-plane array 104 in a 360° circular path in the x-y plane located at z=0. Preferably, the path of focal-plane array results in a translation amplitude of the light pattern that is several times larger than the focal-spot waist.

One skilled in the art will recognize that, by virtue of the relative longitudinal and transverse motions between light distribution LD(z) and focal-plane array 104, the information recorded by the focal-plane array during each exposure period 302 is a fusion of an infinite number of slices of images within focal range 116 (i.e., an integration of LD(z) over a time period equal to T). Knowledge of the PSF of lens 102 and the path of focal-plane array 104 enables recovery of spatial information for scene 112 via deconvolution, as discussed below.

The Forward Model for Computational Imaging with Motion-Encoding

A forward model of camera 100 can provide insight into how image translation and focal sweep during a single exposure period of focal-plane array 104 improve the sampling efficiency for a computation imaging system. Since independent consideration of each color plane is sufficiently representative, a monochromatic forward model of the camera is sufficient and is described by:

g(x, y, t)=∫f(x′, y′, z, t)h(x−x′−η(t), y−y′−ξ(t), ζ(t)−z)dx′dy′dz , (3)

where η, ξ, and ζ are time-dependent spatial translations in x, y, and z, respectively.

It should be noted that elimination of such translations is normally a key goal of prior-art imaging systems because they give rise to motion blur, image jitter and defocus. It is an aspect of the present invention, however, that these relative motions can be exploited to enable physical-layer data compression, increase the rate of information acquisition, and improve estimated image quality.

One skilled in the art will recognize that spatial resolution is limited by wave diffraction, geometric aberration and pixel sampling. In contrast, temporal resolution is limited only by the pixel-sampling rate of focal-plane array 104. Wave diffraction and geometric aberration limits are determined by the structure of the PSF of lens 102. Pixel-sampling limits in space and time are determined by the pixel-sampling functions px(x) and pₜ(t), as discussed by Brady, et al., in “Optical imaging and spectroscopy,” John Wiley & Sons, (2009). The sampled measurement data cube consists of discrete samples of the continuous function:

g(x, y, t)=∫f(x″, y″, z, t)h(x′−x″−η(t′), y′−y″−ξ(t′), ζ(t′)−z)pₓ(x−x′)pₓ(y−y′)pₜ(t−t′)dx″dy″dx′dy′dzdt′. (4)

The impact of translation on this measurement model can be readily understood by considering a two-dimensional space-time model under which a one-dimensional spatial image is translated as a function of time, such as:

g(x, t)=∫f(x″, t′)h(x′−x″−vt′)pₓ(x−x′)pₜ(t−t′)dx″dx′dt′, (5)

where linear motion of the image is assumed as v, during data capture. The Fourier transform of g(x,t) in space and time is given by:

ĝ(u,v)=\hat{f}(u, vu+v)ĥ(u) [symbol] (u) [symbol] (v). (6)

The support of ĥ(u) [symbol] (u) [symbol] (v) in the Fourier (u,v) plane defines the “passband” of the measurement system.

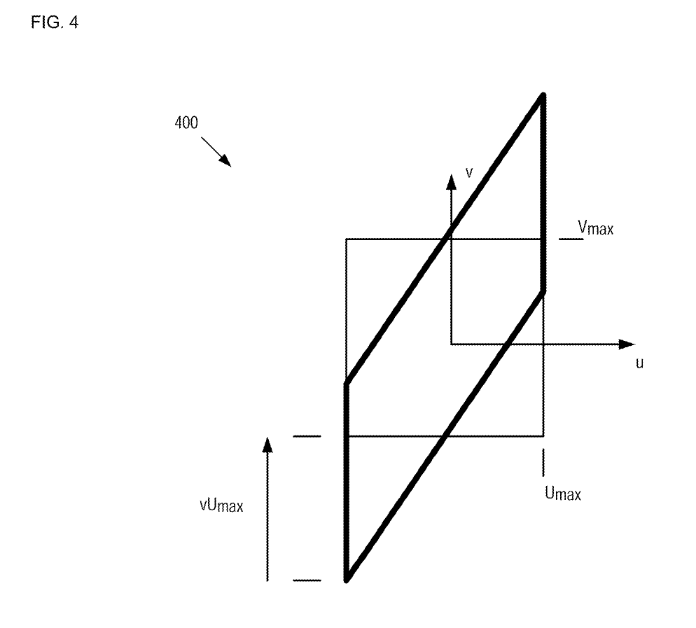

FIG. 4 depicts a schematic drawing showing that the support of ĥ(u) [symbol] (u) [symbol] (v) in the Fourier (u,v) plane defines the “passband” of the measurement system in accordance with the present invention. Plot 400 evinces that the effect of image translation is to shift the region in the Fourier space of \hat{f}(u,v) that passes through the passband to be characterized in the measurement. Assuming a rectangular passband, the square in the figure with extent Uₘₐₓ along the u-axis and extent Vₘₐₓ along the v-axis is the passband through which measurements are obtained. With no image translation, this is also the passband through which object data is obtained. Motion transforms the object mapping, however, such that the dark parallelogram is represents the passband in the object Fourier space. The effect of this change in the passband is to make the image sensitive to higher frequency (e.g., faster) components than would be normally observed at the cost of reducing the extent of the passband along the u-axis at a fixed frequency. Specifically, the extent of the passband at v=0 is now 2V_{max/v}<2Uₘₐₓ. If the velocity is N pixels/frame, the spatial passband at a given frequency is reduced by at least a factor of N. The total area of the passband in the object space is the same as the area in sample space, 4UₘₐₓVₘₐₓ—independent of the image velocity.

The effect of image translation during recording is, therefore, a shear in the effective sampling passband. If information is uniformly distributed over the object Fourier space, such a shift has no effect on the overall information rate. In practice, however, information in natural images tends to be clustered at low spatial and temporal frequencies. In such cases, image translation blurs the recorded image and reduces the overall information rate. In many cases, however, the low frequency information is well characterized or highly compressible and one does find the potential of sensor translation to increase the maximum frequency response attractive. Translation may be particularly attractive overcoming aliasing limits associated with subsampling due to interlaced color filtering, as illustrated by Kittle, et al., in “Multi-frame image estimation for coded aperture snapshot spectral imagers.” Applied Optics, Vol. 49, pp. 6824-6833 (2010). In similar fashion, translation of codes, or of the image plane, overcomes aliasing limits to achieve spatial super-resolution.

The multi-dimensional nature of the image, allowing image motion in both the x- and y-planes, is particularly significant in this respect because motion over approximately 10 pixels per frame in a curved path achieves a net increase in temporal frequency resolution by a factor of 10, while reducing lateral resolution in each direction by \sqrt{10}. The increase in reshaping of the bandpass and the increase in temporal resolution associated with image translation can be understood in various ways. Most obviously, if an object in a scene happens to be moving as a function of time, then better focus and better imaging is obtained if the image moves in the same direction. More subtly, if a spatially stationary object changes as a function of time, its temporal evolution can be mapped onto a spatial pattern by image motion. For example, if an object is described as f(x, t)=δ(x)fₜ(t), and we assume that h(x)=δ(x), then the sensed data with image translation is given by:

g(x, t)=∫fₜ(t′)pₓ(x−vt′)pₜ(t−t′)dt′, (7)

Approximating the transverse spatial sampling as pₓ(x)=δ(x), then:

g(x, t)=f(x|v)p(t−x/v′)dt′ (8)

which means that the motion maps the temporal signal ft(t) onto a spatial pattern that can be analyzed with effective bandpass 2(Vₘₐₓ+vUₘₐₓ).

### Three-Dimensional Imaging

The addition of image translation during exposure provides particular advantage in the case of a scene having a large depth-of-field, or when the object range of the scene is unknown. In such situations, the initial PSF is blurred by defocus and the impact of motion is not pronounced for defocused ranges.

In a typical conventional camera, the process of finding the correct focal state is separated from the process of image capture. Whether done manually by the camera user or via an autofocus system (using secondary range sensors or image-contrast analysis), the lens system is normally adjusted to obtain a “proper” focus prior to recording an image. Such an approach is sub-optimal for recording a scene in which the object range is dynamic or where the scene spans multiple ranges, however. As a result, numerous alternative strategies for obtaining extended depth-of-field and/or digital refocus have been developed, such as “wavefront coding” strategies and “light-field” strategies. In wavefront coding, aberrations or “codes” are deliberately introduced into the lens aperture to give rise to focal-invariant or coded PSFs. In light field strategies, microlens arrays are used to interlace multiple range sampling. Unfortunately, these strategies reduce lateral resolution to obtain improved imaging over range.

It is an aspect of the present invention, however, that moving an image during focal sweep affords the same advantages as wavefront coding and light field imaging, but without some of their disadvantages. The combination of image motion and focal sweep can produce a range invariant or range coded PSF that is comparable to that obtained using these prior art approaches. In contrast to wavefront coding and light field imaging, however, motion coding can be used adaptively. For example, once motion has been applied to analyze the focal state or to capture an extended depth of field image, it may be turned off or reduced to allow high transverse-resolution image capture.

The simplest way to use image translation to encode range and focal state is to simultaneously translate the image longitudinally and laterally, as in operations 202 and 203, respectively. The model for such an approach is:

g(x, y, t)=∫f(x″, y″, z, t)h(x′−x″−y′−y″, αt′−z)pₓ(x−x′)pₓ(y−y′)pₜ(t−t′)dx″dy″dx′dy′dzdt′, (9)

where v and α are transverse and focal-longitude translation velocities. It can be shown that images captured under this model enable single-frame extended-depth-of-field imaging comparable to wavefront coding and light-field imaging. Assuming that transverse resolution is dominated by the optical PSF and that temporal sampling involves measurement over a single time step, the recorded image is given by:

g(x, y)=∫∫∫∫₀^{T}f(x′, y′, z)h(x−x′−vt, y−y′, αt−z)dx′dy′dzdt, (10)

where the scene is assumed to be static over the capture time frame (i.e., an exposure frame). Integrating Eq. 10 over time enables a definition of the spatial PSF as:

hᵣ(x, y, z)=∫₀^{T}h(x−vt, y, αt−z)dt. (11)

By approximating the three-dimensional-imaging impulse response of lens 102 by a Gaussian mode, the system impulse response (i.e., PSF) can be modeled for transverse velocity, v.

As discussed above and with respect to operation 203, in the illustrative embodiment, actuator 106 moves focal-plane array 104 in a 360° circular path in the x-y plane located at z=0. Specifically, relative to the image formed by lens 102, focal-plane array 104 is moved in a circular motion by setting the x-axis position as η(t)=a cos(ωt) and the y-axis position as ξ(t)=a sin(ωt).

It is an aspect of the present invention that by translating the image formed by lens 102 in both the x- and y-direction during a focal sweep of the lens, three-dimensional information about scene 112 can be reconstructed by either blind or model-based deconvolution.

In order to demonstrate the advantages afforded by the present invention, it is instructive to consider the PSF for different transverse velocities, v.

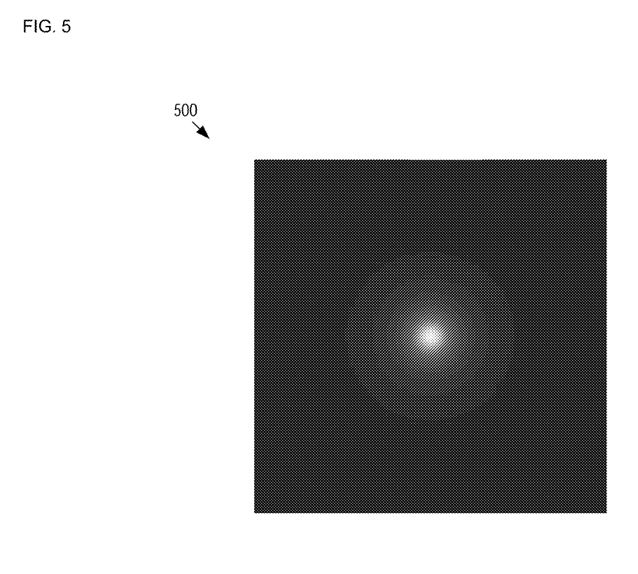

FIG. 5 depicts a simulated PSF for a camera having a stationary focal-plane array. Plot 500 shows a simulated PSF for camera 100 for a transverse velocity, v, of zero. Plot 500 evinces that, in the absence of transverse motion, the PSF is a circularly symmetric blur associated a circular focal sweep.

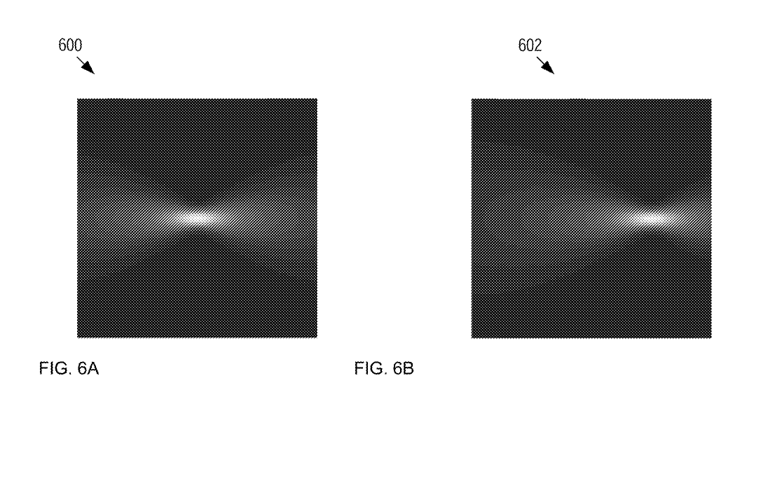

FIGS. 6A-B depict simulated PSFs for two (x,y) points in the object space of camera 100, wherein the PSFs are obtained while focal-plane array 104 is moved linearly in a transverse direction during an exposure frame in accordance with the present invention.

Plot 600 shows a PSF for a first object point in scene 112. In contrast to what is shown in plot 500, when a relative motion between the image formed by lens 102 and focal-plane 104 is induced, the longitudinal structure of the three-dimensional PSF is laid out in a transverse-time-integrated PSF.

As with wavefront coding and other methods for obtaining extended-depth-of-field images, image translation during focal sweep, in accordance with the present invention, enables formation of a coded PSF that can be computationally deconvolved to recover a 3D or all-in-focus image.

Plot 602 depicts a PSF for a second object point having a different range and transverse point from optical axis 110 than the first object point, where focal-plane array 104 is moved linearly in a transverse direction in accordance with the present invention.

Each object point in scene 112 induces the PSF at its corresponding range and transverse point. It can be seen from plots 600 and 602 that during the focal sweep in an exposure frame, the PSF is shifted to appear at a point corresponding to its range.

It should be noted, however, that while one can analyze this shift to find the range, there is ambiguity between the transverse position of the object point and the range. This ambiguity can be removed by translating the image in two dimensions during the focal sweep, as described above and with respect to operation 203. As a result, while a relative transverse motion between the light distribution and focal-plane array that is linear is within the scope of the present invention, a relative motion that has a path in two transverse dimensions is preferred. It should be further noted that the relative motion induced between the light distribution and the focal-plane array does not need to be restricted to a plane that is orthogonal to optical axis 110 as long as the motion includes at least a portion that can be projected onto such a plane.

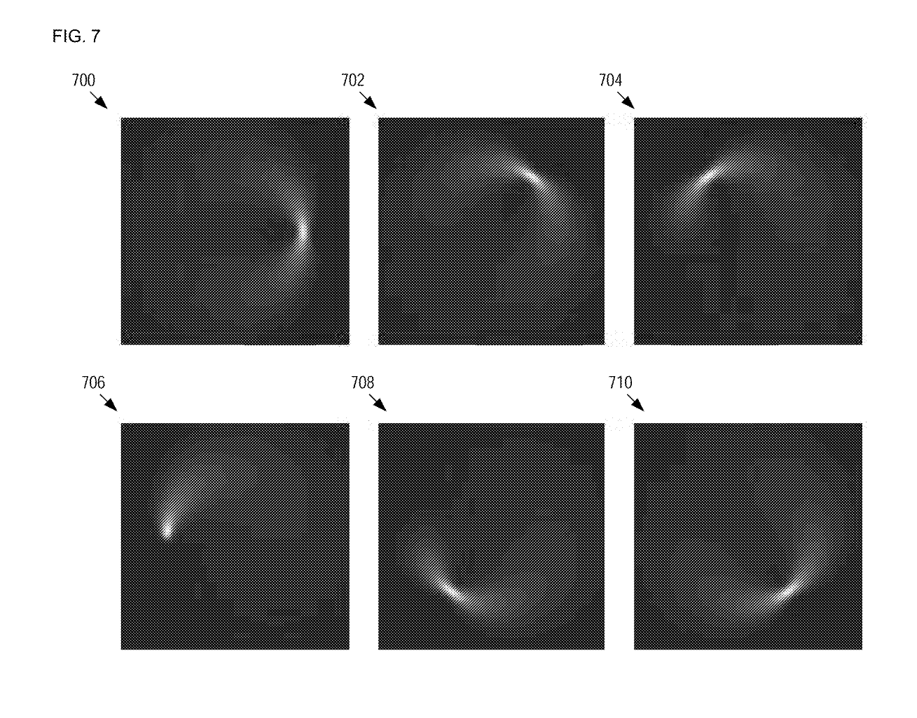

FIG. 7 depicts the simulated PSF for camera 100 at different ranges in accordance with the illustrative embodiment of the present invention. For the circular motion of focal-plane array 104 induced in operation 203, with translation amplitude approximately six-times larger than the focal-spot waist, plots 700, 702, 704, 706, 708, and 710 depict the observed PSFs for the imaging system at six different values of z in the object space of lens 102.

It can be seen from plots 700, 702, 704, 706, 708, and 710 that each object point induces the PSF at its corresponding range and transverse point. During a focal sweep, the PSF is shifted to appear at a point corresponding to its range, which affords embodiments of the present invention with significant advantages over prior-art imaging methods.

For a rotation rate of 360° over one focal sweep, the angle at which the maximum in the PSF occurs uniquely indicates the range of an object point. Analysis of the PSF makes it possible to find the PSF and then estimate the range by finding the angle to the PSF peak. Examples of such an approach are described by Joshi, et al., in “PSF estimation using sharp edge prediction,” Computer Vision and Pattern Recognition, Proceedings of the 2008 IEEE Conference on Computer Vision and Pattern Recognition 2008, Jun. 23-28, 2008, pp. 1-8.

Returning now to method 200, at the end of operation 203, focal-plane array 104 has recorded a composite image of scene 112 that is a fusion of an infinite slices of images integrated over the focal range of lens 112 and the path of the focal-plane array during exposure frame 302.

At operation 204, focal-plane array 104 provides this composite image to processor 108 as encoded digital output signal 114.

At operation 205, a digital image of scene 112 is reconstructed by deconvolving encoded digital output signal 114 with the PSF of camera 100 and a model for the transverse motion of focal-plane array 104.

As mentioned above, the present invention enables the ability to employ motion coding in an adaptive fashion. This is notably in contrast to wavefront coding and light field imaging. As a result, method 200 further includes several optional operations performed after the end of exposure frame 302.

At optional operation 206, the focal state of scene 112 is established. In some embodiments, optional operation 206 alternatively comprises capturing an extended depth-of-field image of scene 112.

At optional operation 207, processor 108 controls actuator 106 to reduce the magnitude of the transverse motion of focal-plane array 104 (or, in some embodiments, stop its motion completely).

At optional operation 208, a high transverse-resolution image of scene 112 is captured in conventional fashion.

In some embodiments, the operation 206 is performed based on the image reconstruction performed during exposure frame 302-1 and operations 207 and 208 are performed during exposure frame 302-2.

### Three-Dimensional Imaging Examples

In order to demonstrate the advantages afforded by the present invention, simulated image reconstructions for a scene having an extended depth-of-field are presented here for three different image-sweeping strategies.

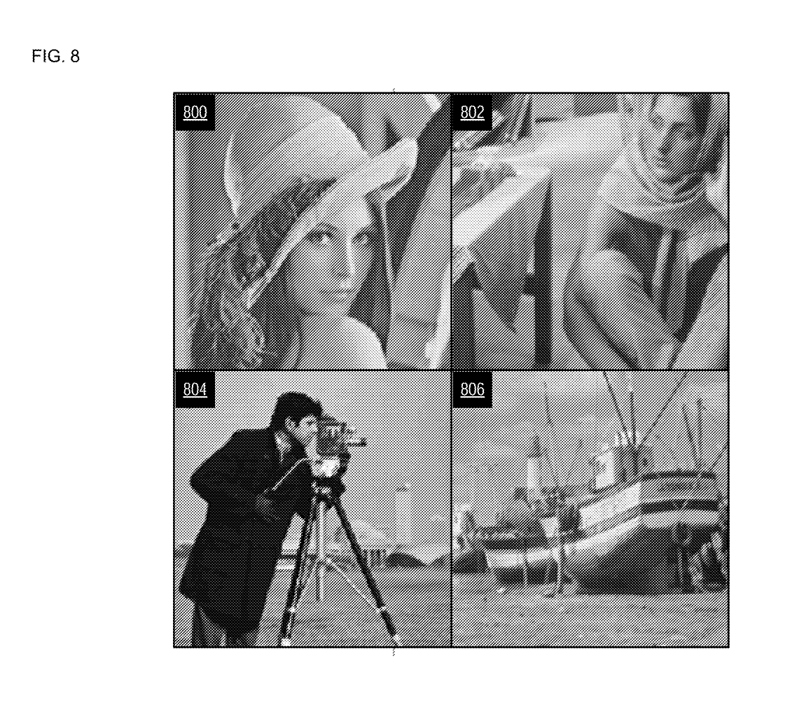

FIG. 8 depicts four different well-known simulation images provided as an in-focus simulated object.

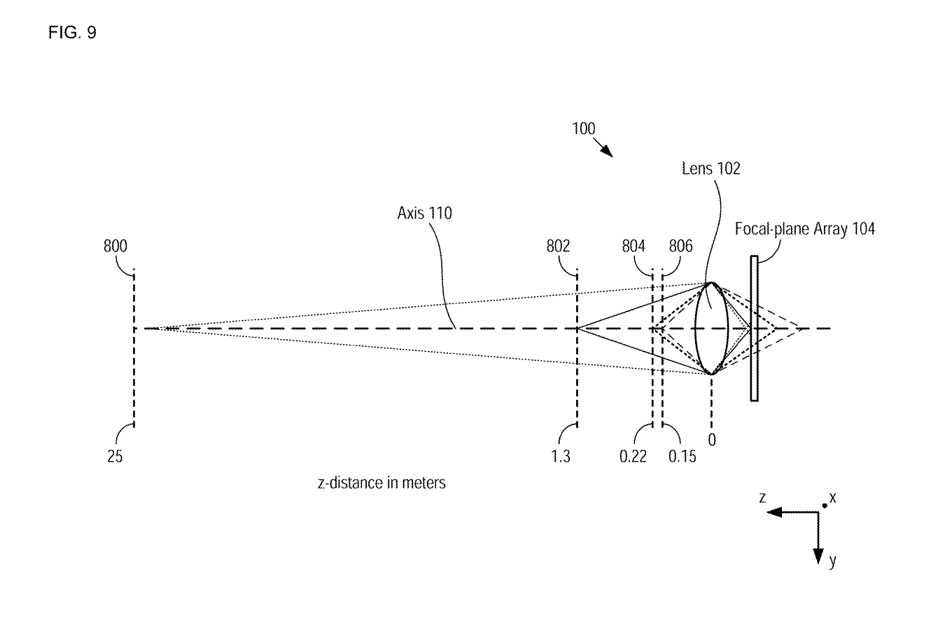

FIG. 9 depicts an arrangement of camera 100 and objects 800, 802, 804, and 806, wherein the four objects are located at different distance along the z-axis of the camera. Specifically, images 800, 802, 804, and 806 are modeled at distances, z, of 25 m, 1.3 m, 0.22 m, and 0.15 m, respectively, while the focus of lens 102 is on image 802 (i.e., the camera is focused at a distance of 1.3 m). The simulations of images 800, 802, 804, and 806 are assumed as Gaussian kernels with standard deviations, σ, that vary with defocus error, since Hermite-Gaussian beams are eigenfunctions of the Fresnel-propagation transformation. The images are also approximated as Nyquist-sampled with diffraction-limited optics.

Based on the assumptions above, the defocused blur kernel, h(x,y,zₒ,z) for an object plane zo conjugate to an image-space distance z from camera 100 varies according to the focused beam waist, wo, and the optical defocus relative to the object plane as:

$$h ( x , y , {z}_{o} , z ) = \frac{1}{{w}_{0}^{2} + {σ}^{2} ( {z}_{o} , z )} exp ( - π \frac{( {x}^{2} + {y}^{2} )}{{w}_{0}^{2} + {σ}^{2} ( {z}_{o} , z )} ) , \qquad ( 12 )$$

where the defocus affects the blur kernel's standard deviation for a pixel pitch, A, according to the paraxial focus error:

$${σ}^{2} ( {z}_{o} , z ) = \frac{Dz}{2 Δ} \vert \frac{1}{F} - \frac{1}{{z}_{o}} - \frac{1}{z} \vert , \qquad ( 13 )$$

and where F denotes the system focal length and D denotes the entrance pupil diameter. In the simulations, F=5 mm and D=1 mm.

Each image is simulated as being taken by camera 100, while the camera is focused on image 802 with added white Gaussian noise.

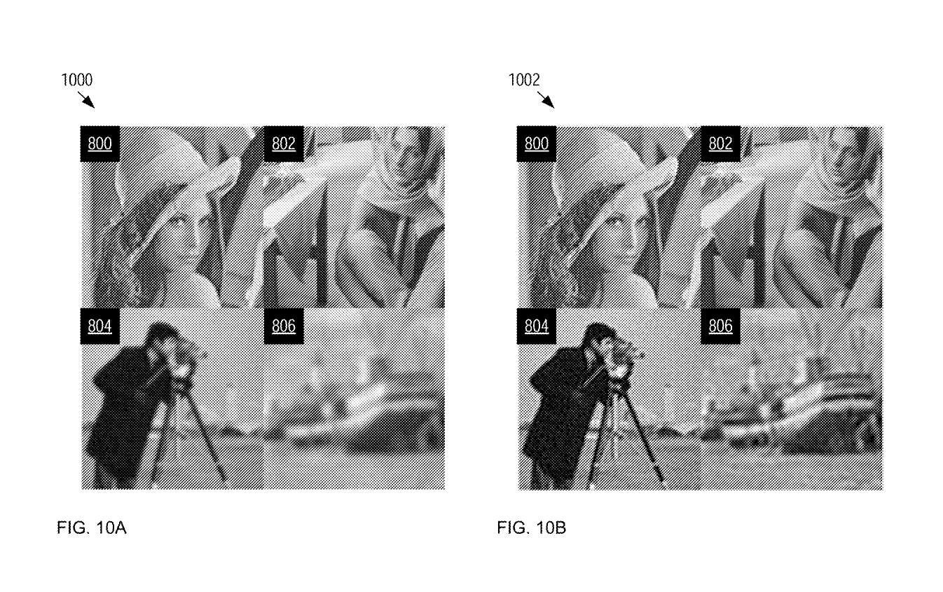

FIG. 10A depicts reconstructed images 800, 802, 804, and 806 where one focus position is used.

FIG. 10B depicts the reconstructed images, where each is deconvolved with its perpetrating kernel.

Plots 1000 and 1002 demonstrate that the corresponding defocused impulse responses deteriorate rapidly as focal-plane array 104 becomes conjugate to distances closer than the true object distance.

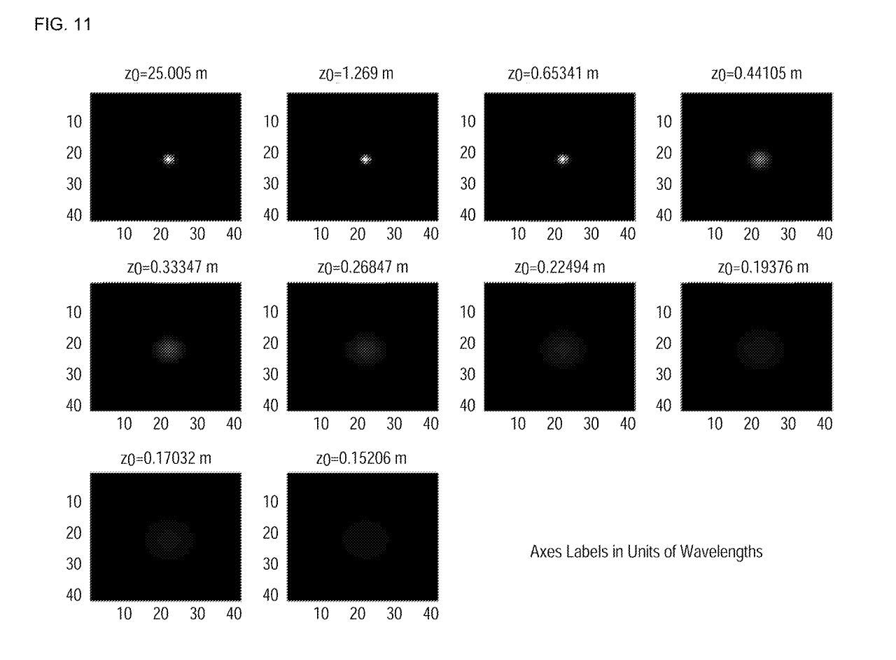

FIG. 11 depicts plots of the conventional blur kernels for the reconstructed images depicted in plot 1002. It should be noted that the plots shown in FIG. 11 represent images taken without any relative transverse motion between the optical images and the focal plane array. The plots are shown with axes in units of wavelengths. As would be expected by one of skill in the art, the high-frequency components within the images, which are low-pass filtered by Gaussian kernels, are irrecoverable by deconvolution.

It is an aspect of the present invention, however, that high spatial and temporal frequencies can be preserved during the image formation process for objects of arbitrary distance from the camera. In accordance with the present invention, sweeping the detector a distance Δz=αT in the image space of lens 102 during the integration period T results in the EDOF kernel:

h_{S,1}(x, y, z₀)=∫₀^{T}h(x, y, z₀, ζ(t′)−z)dz, (14)

where ξ(t)=αt and Δ_{z}=185 microns in the following simulations (i.e., the detector sweeps a distance from 5 mm to 5.185 mm behind lens 102 in the image volume; α=0.185 mm/T). This corresponds to sweeping object distances ranging from 25 meters to 15 cm. Using ten equally-spaced (in image space) candidate range bins, of which the simulated objects 800, 802, 804, and 806 correspond to the first, second, sixth, and tenth PSFs.

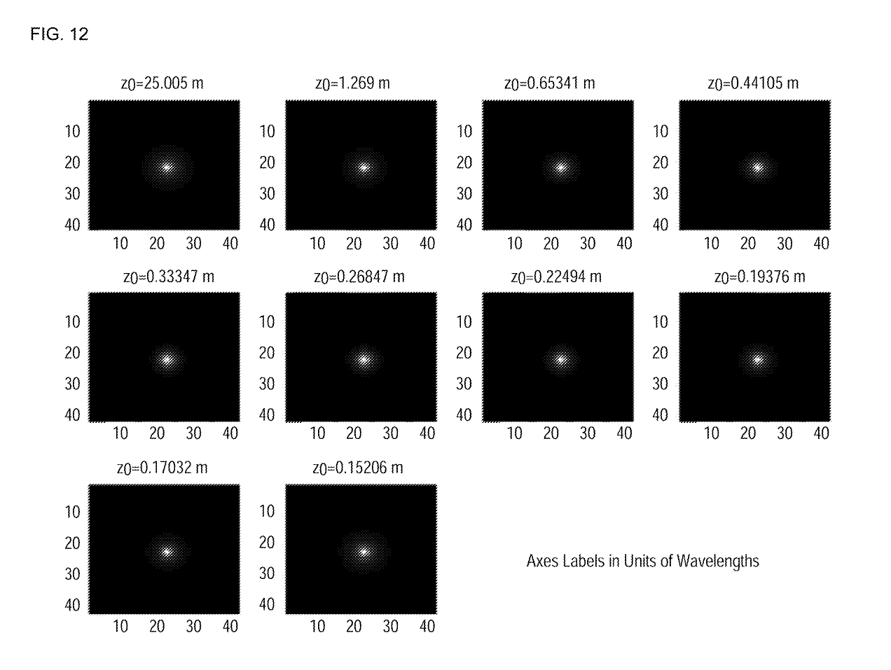

FIG. 12 depicts plots of EDOF kernels taken with induced longitudinal motion between light distribution LD(x) and focal-plane array 104 (i.e., with a focal sweep of lens 102) but without transverse motion of the focal-plane array. It should be noted that the kernels consist of summations of Gaussians.

These focal-sweep kernels have been shown to be nearly depth-invariant by Liu, et al., in “Extended depth-of-field microscopic imaging with a variable focus microscope objective,” Optics Express, Vol. 19, pp. 353-362 (2011).

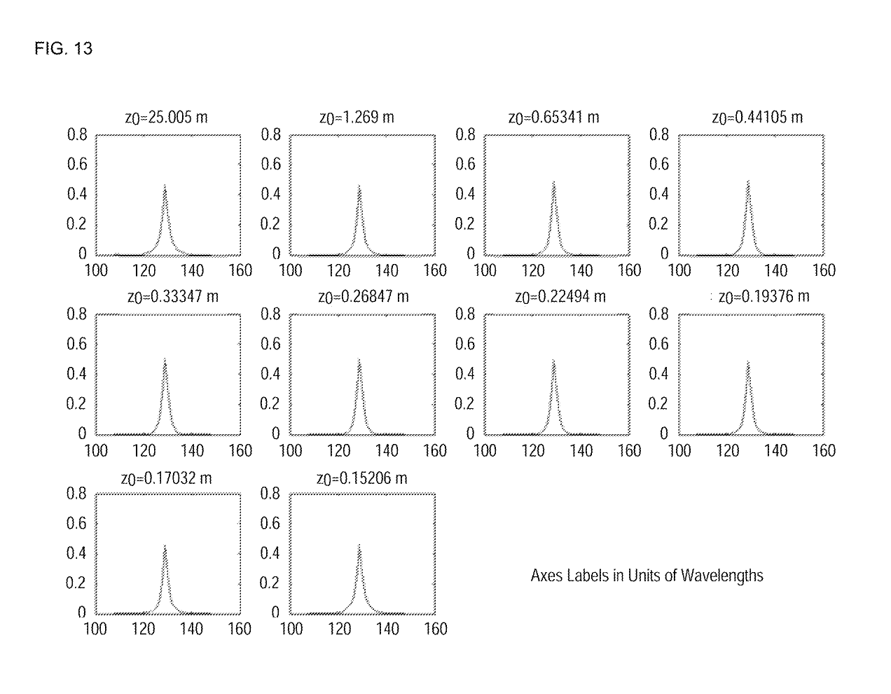

FIG. 13 depicts plots of the cross-sections of the EDOF kernels shown in FIG. 12. The cross-sections shown in FIG. 13 illustrate that these focal-sweep kernels are substantially depth invariant.

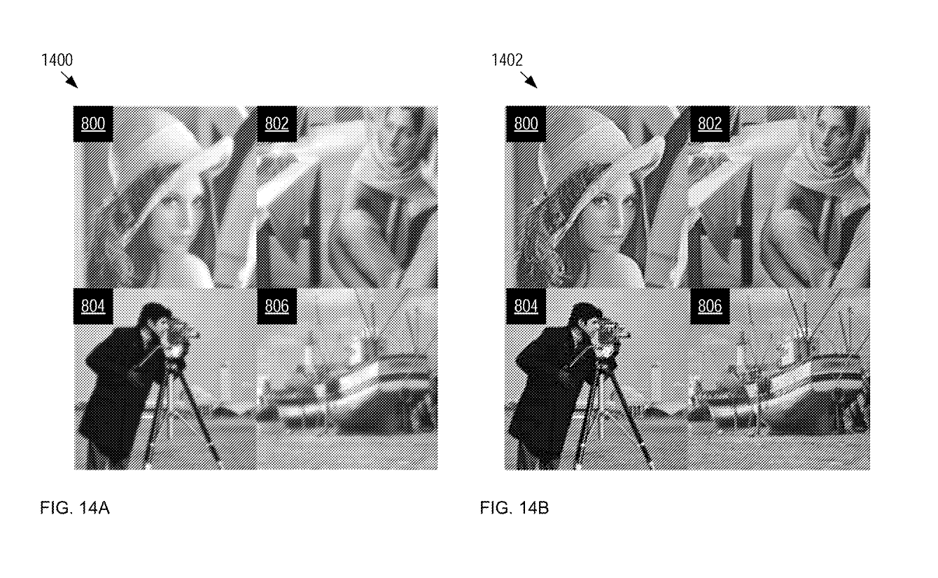

FIG. 14A depicts reconstructed images 800, 802, 804, and 806 as corrupted by the EDOF kernels taken with induced longitudinal motion but without transverse motion of focal-plane array 104.

FIG. 14B depicts the reconstructed images shown in plot 1400. Each image in plot 1402 is deconvolved with its perpetrating kernel.

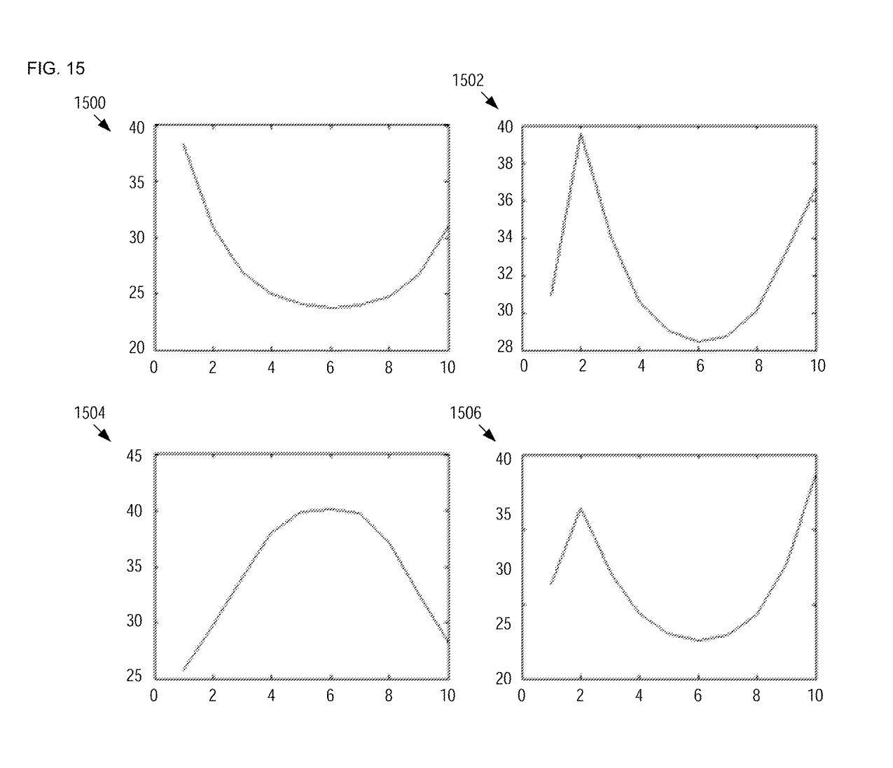

FIG. 15 depicts plots of the peak signal-to-noise values for images 800, 802, 804, and 806 after deconvolution. Plots 1500, 1502, 1504, and 1506 show the candidate-wise peak signal-to-noise (PSNR) values versus different kernels, where the correct kernel in each plot is 1, 2, 6, and 10, respectively.

As discussed above, the present invention augments the use of longitudinal motion between the light distribution and the focal-plane array by also inducing relative transverse motion between them. This enables a depth-encoding EDOF blur kernel to be obtained. In some embodiments of the present invention, the transverse motion comprises only linear translation along only one dimension within a plane that is orthogonal to optical axis 110. It should be noted, however, that even simple one-dimensional translation affords embodiments of the present invention advantages over the prior art. These advantages can be seen by an example wherein a depth-encoded EDOF blur kernel is obtained by translating focal-plane array 104 linearly in the x direction with a speed v. The kernel is then given by:

h_{S,2}(xy, z₀)=∫₀^{T}h(x−η(t), y, zₒ, ζ(t′)−z)dz, (15)

where ζ(t)=αt and η(t)=vt.

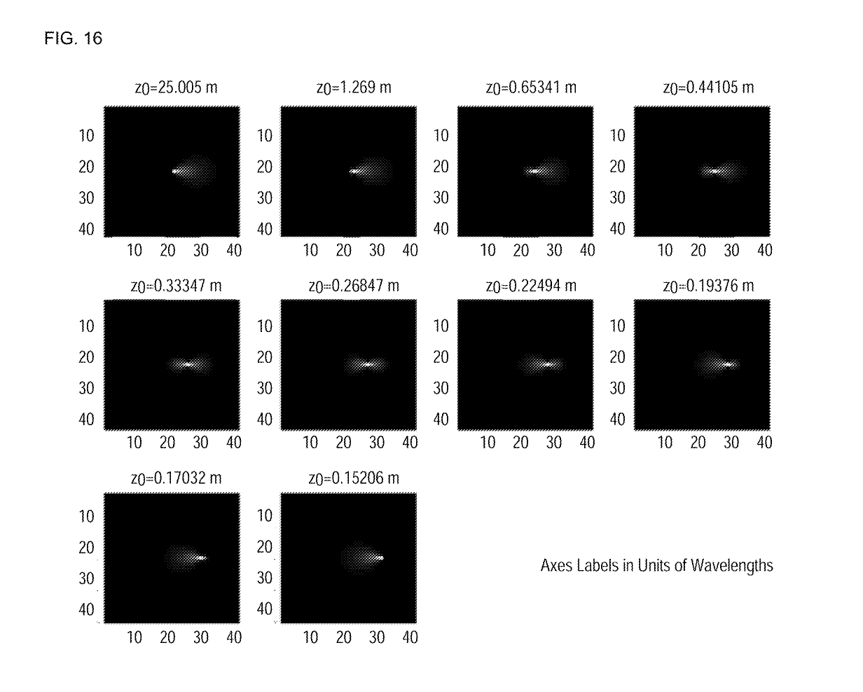

FIG. 16 depicts plots of EDOF kernels taken with induced longitudinal and linear transverse motion. FIG. 16 shows the kernel for the target object distances with v=10 pixels/T.

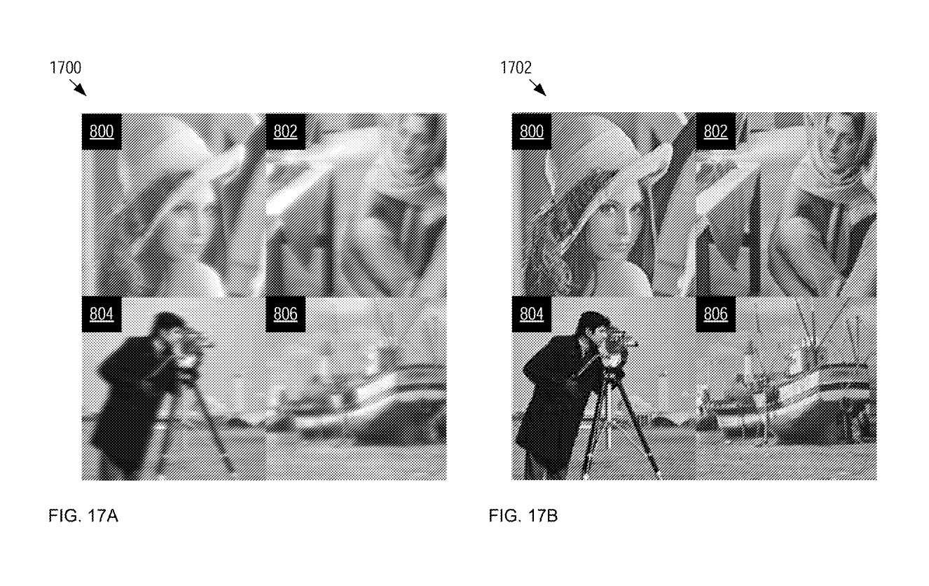

FIG. 17A depicts reconstructed images 800, 802, 804, and 806 as corrupted by the EDOF kernels taken with induced longitudinal motion between light distribution LD(x) and focal-plane array 104 and transverse motion of the focal-plane array in one dimension.

FIG. 17B depicts the reconstructed images shown in plot 1700. Each image in plot 1702 is deconvolved with its perpetrating kernel.

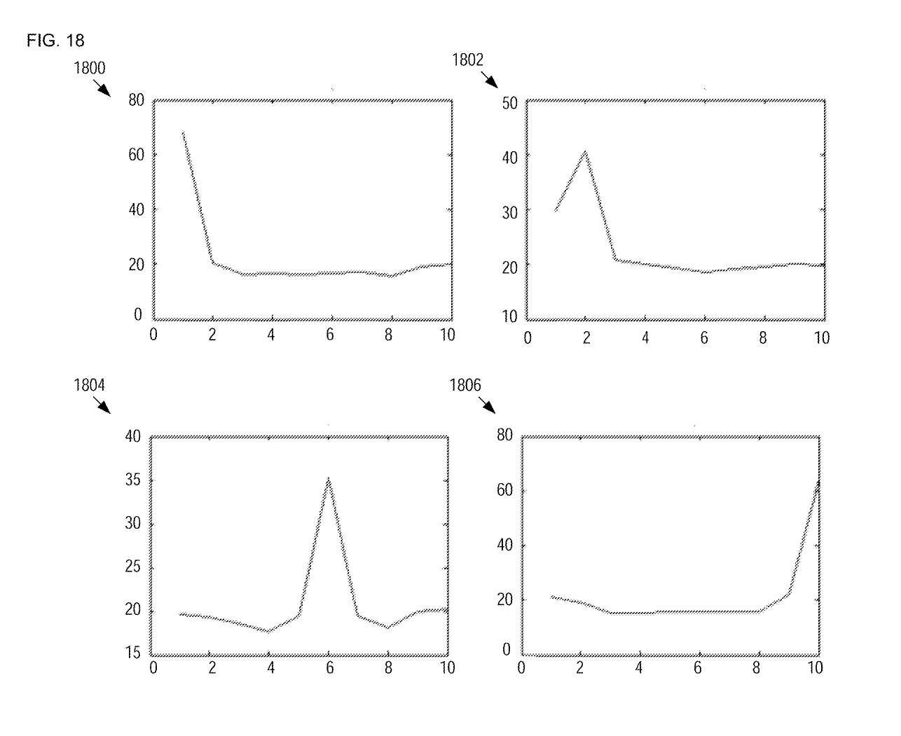

FIG. 18 depicts plots of the peak signal-to-noise values for images 800, 802, 804, and 806 after deconvolution as depicted in plot 1702. Plots 1800, 1802, 1804, and 1806 show the candidate-wise peak signal-to-noise (PSNR) values versus different kernels, where the correct kernel in each plot is 1, 2, 6, and 10, respectively. Note the bottom left and top right images have an appearance characteristic of handshake in the x direction. This effect is attributed to greatest power residing in the side lobes of the corresponding dumbbell-shaped EDOF PSF.

It should be noted that, although it appears the optimal focus distance from images can be uniquely determined from a two-dimensional translation (i.e., focus and a one-dimensional translation of focal-plane array 104 in the x-y plane), in practice an ambiguity exists between the position of the PSF and the true location on the focal-plane array that corresponds to best focus. Since the contents of the true image are not known prior to in-focus capture, the optimal focal position cannot be determined without employing another metric—namely, adding another dimension of transverse motion between the light distribution and the focal-plane array.

Returning now to the illustrative embodiment, in operation 203, actuator 106 moves focal-plane array 104 in a circular path that is temporally aligned with the duration of the exposure frame of camera 100. Rotating the focal-plane array as a function of time enables the true object path to be uniquely encoded into the measurement. Rotation of the sensor array through angle, θ, during the exposure frame gives rise to blur kernels of the form:

h_{S,3}(x, y, z₀)=∫₀^{T}h(x−η(t), y−ξ(t), z₀, ζ(t)−z)dt, (16)

where η(t)=A cos(θt), ξ(t)=A sin(θt), and ζ(t)=αt.

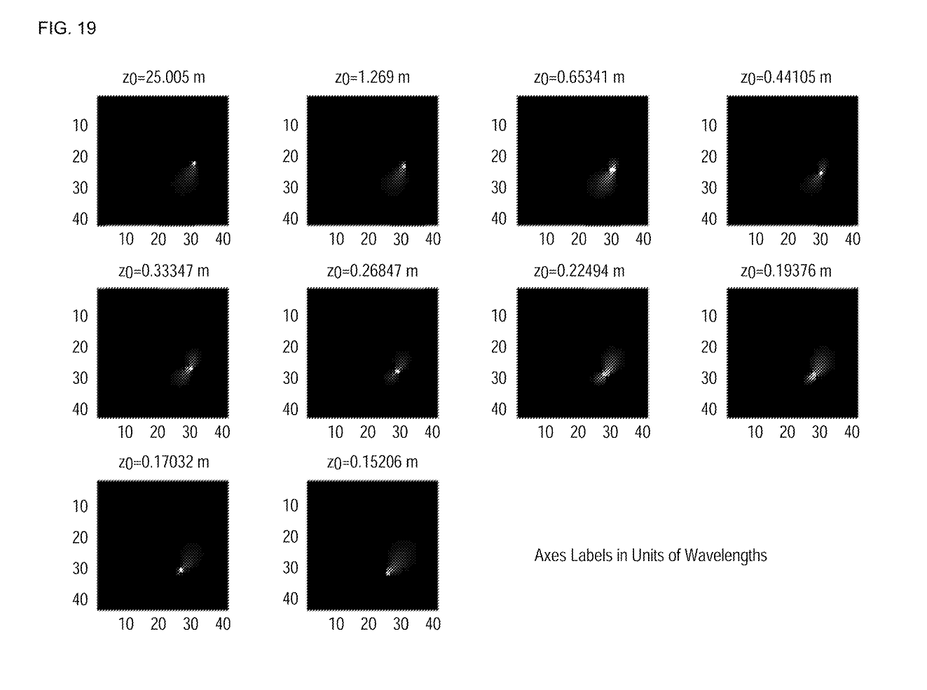

FIG. 19 depicts plots of blur kernels taken with induced longitudinal motion between light distribution LD(x) and focal-plane array 104 and transverse motion of the focal-plane array in two dimensions. FIG. 19 shows the kernel that results from translating focal-plane array 104 in a quarter circle having a 5-pixel radius during exposure frame 302.

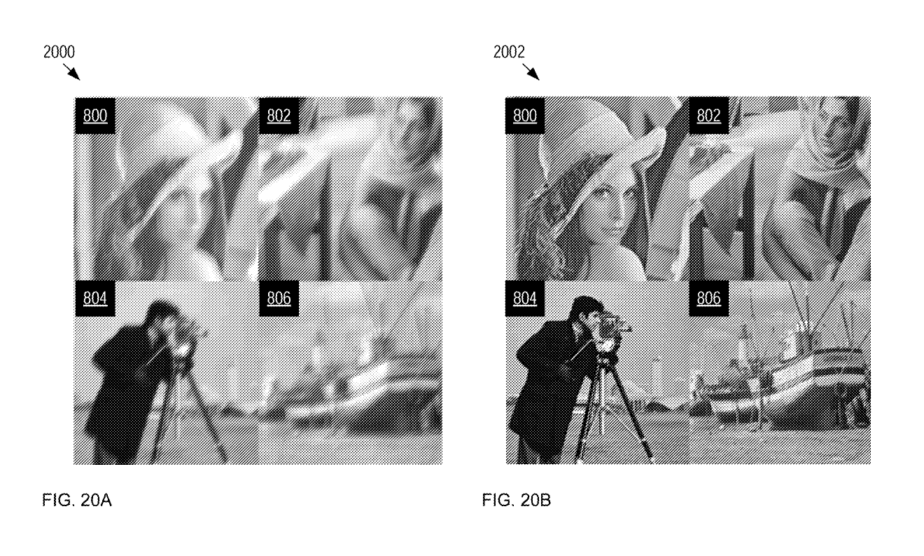

FIG. 20A depicts reconstructed images 800, 802, 804, and 806 as corrupted by the EDOF kernels taken with induced longitudinal motion between light distribution LD(x) and focal-plane array 104 and transverse motion of the focal-plane array in two dimensions.

FIG. 20B depicts the reconstructed images shown in plot 2000. Each image in plot 2002 is deconvolved with its corresponding blur kernel.

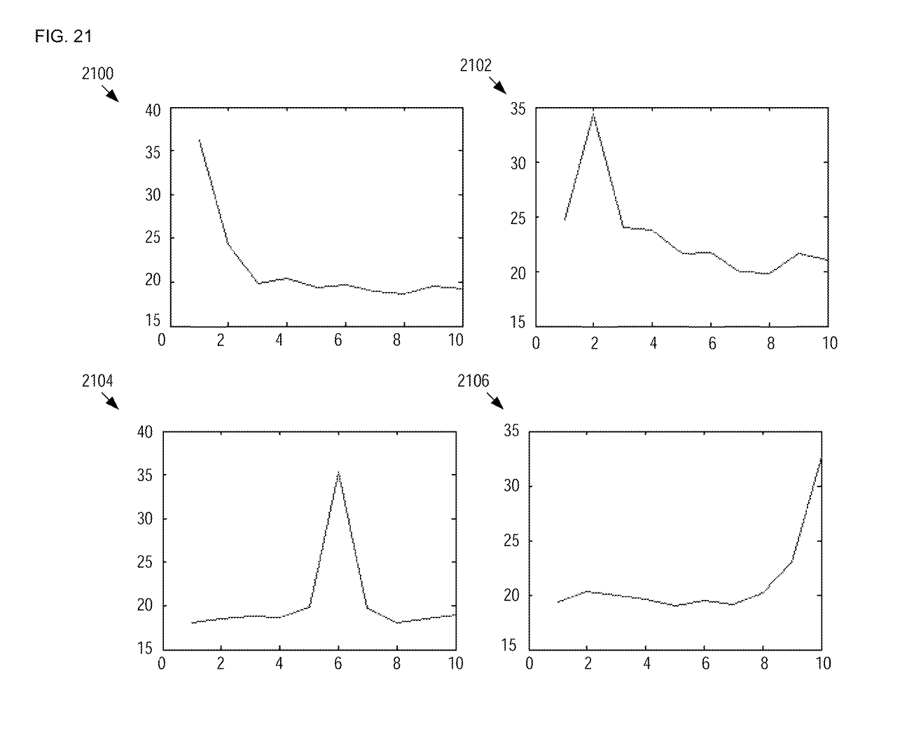

FIG. 21 depicts plots of the peak signal-to-noise values for images 800, 802, 804, and 806 after deconvolution as depicted in plot 2002. Plots 2000, 2002, 2004, and 2006 show the candidate-wise peak signal-to-noise (PSNR) values versus different kernels, where the correct kernel in each plot is 1, 2, 6, and 10, respectively. Note the bottom left and top right images have an appearance characteristic of handshake in the x direction. This effect is attributed to greatest power residing in the side lobes of the corresponding dumbbell-shaped EDOF PSF.

As discussed above and with respect to two-dimensional detector translation, the PSNR data shown in FIG. 21 suggests that the maximum focus and correct kernel is identified with this framework. It should be noted that, although error criteria were used to evaluate accuracy in the simulations, other approaches can be used without departing from the scope of the present invention. As demonstrated herein, the present invention provides a uniquely-identifiable PSF for autofocus and ranging applications.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method for forming a digital image of a scene, the method comprising:
forming an optical image at a first position on a first axis;
locating a focal-plane array at a second position on the first axis, wherein the first position and second position are separated along the first axis by a first distance;
receiving a light distribution at the focal-plane array, the light distribution being based on the optical image and the first distance;
converting the light distribution into a digital output signal over a first exposure period;
controlling at least one of the first position and the second position to scan the first distance through a first range during the first exposure period; and
inducing a first relative motion between the focal-plane array and the light distribution during the first exposure period, wherein the first relative motion is unaligned with the first axis;
wherein the scanning of the first distance through the first range and the first relative motion collectively encode the digital output signal to form an encoded digital output signal.

2. The method of claim 1 wherein the first relative motion is within a plane that is substantially orthogonal to the first axis.

3. The method of claim 1 wherein the first relative motion is a two-dimensional motion within a plane that is substantially orthogonal to the first axis.

4. The method of claim 1 wherein the first relative motion includes a curved path within a plane that is substantially orthogonal to the first axis.

5. The method of claim 1 wherein the first relative motion is induced by moving at least one of (1) the focal-plane array and (2) at least a portion of a lens system that forms the optical image.

6. The method of claim 1 wherein the first relative motion is induced by enabling at least one of the focal-plane array and a lens system that forms the optical image to move in response to an externally applied motion.

7. The method of claim 1 further comprising estimating the digital image based on the first relative motion and the optical image.

8. The method of claim 1 further comprising estimating the digital image by operations comprising:
receiving a plurality of electrical signals at a processor, the plurality of electrical signals being generated by the focal-plane array based on the light distribution received throughout the first exposure period, wherein the plurality of electrical signals collectively define an encoded digital output signal; and
deconvolving the encoded digital output signal with a function that is based on a blur kernel for a lens system that forms the optical image.

9. The method of claim 8 further comprising determining the blur kernel based on a calibrated multidimensional impulse response of the lens system and the first relative motion.

10. The method of claim 1 further comprising:
determining a focal state of the scene based on the first relative motion between the focal-plane array and the light distribution during the first exposure period;
fixing the relative position between the focal-plane array and the light distribution; and
recording an image of the scene during a second exposure period.

11. A computational imaging system comprising:
a lens system operative for forming an optical image of a scene at a first position along a first axis; and
a focal-plane array that is located at a second position along the first axis such that the focal-plane array receives a light distribution that is based on the optical image and a first distance between the first position and the second position along the first axis, wherein the lens system and focal-plane array are dimensioned and arranged to scan the first distance through a first range during the exposure period, and wherein the focal-plane array is operative for converting the light distribution into a digital image over an exposure period;
wherein the lens system and focal-plane array are dimensioned and arranged to enable a relative motion between the focal-plane array and the light distribution during the exposure period, the relative motion being unaligned with the first axis; and
wherein the relative motion and the scan of the first distance through the first range during the exposure period is operative for encoding the digital output signal to form an encoded digital output signal.

12. The system of claim 11 further comprising an actuator that is operative for imparting the relative motion between the focal-plane array and the light distribution.

13. The system of claim 12 wherein the actuator is operative for imparting the relative motion such that it is within a first plane that is substantially orthogonal to the first axis.

14. The system of claim 13 wherein the actuator is operative for imparting the relative motion such that it is a two-dimensional motion within the first plane.

15. The system of claim 13 wherein the actuator is operative for imparting the relative motion such that it is a curved motion within the first plane.

16. The system of claim 11 further comprising a processor that is operative for computing a digital image of the scene by deconvolving the encoded digital output signal with a function that is based on a blur kernel for the lens system.
